(19) United States
(12) Patent Application Publication
(10) Pub. No.: US 2025/0379909 A1
(43) Pub. Date: Dec. 11, 2025

(54) SERVICE-ORIENTED ARCHITECTURE IN A VEHICLE

(71) Applicant: Ford Global Technologies, LLC, Dearborn, MI (US)

(72) Inventor: Girish Kumar Goyal, Fremont, CA (US)

(73) Assignee: Ford Global Technologies, LLC, Dearborn, MI (US)

(21) Appl. No.: 18/739,763

(22) Filed: Jun. 11, 2024

(51) Int. Cl. H04L 67/12; B60R 16/023; H04L 67/55

(52) U.S. Cl. CPC H04L 67/12; H04L 67/55; B60R 16/0231

(57) ABSTRACT

A vehicle system includes a plurality of electronic control units programmed to execute a service-oriented architecture including a publisher and a subscriber. The publisher is programmed to share a buffer in memory, resulting in a share message being transmitted through the service-oriented architecture, the share message indicating that the buffer is shared; write data to the buffer; upon writing the data to the buffer, transmit a publish message through the service-oriented architecture, the publish message indicating that the data is stored in the buffer, the publish message lacking the data; and wait until receiving an indication of a completion message from the subscriber before writing new data to the buffer. The subscriber is programmed to read the data from the buffer; and upon reading the data in the buffer, transmit the completion message through the service-oriented architecture, the completion message indicating that the subscriber read the data.

### BACKGROUND

A service-oriented architecture is a software environment in which applications on a network act as publishers or subscribers for message topics. A message topic is a category of data or update for which messages can be sent between applications. An application can be a publisher or a subscriber with respect to a specific message topic. A publisher for a given message topic sends messages about the message topic to subscribers of that message topic.

### BRIEF DESCRIPTION OF THE DRAWINGS

FIG. 1 is a block diagram of an example vehicle.

FIG. 2 is a block diagram of an example service-oriented architecture of the vehicle.

FIG. 3 is a diagram of entities in the service-oriented architecture interacting to share a buffer.

FIG. 4 is a flowchart of an example process for sharing buffers between the entities of the service-oriented architecture.

### DETAILED DESCRIPTION

The vehicle system described herein provides a computationally efficient manner of communication within a service-oriented architecture on board a vehicle. Some publishers, e.g., distributing image data from cameras, can produce large quantities of data at a high rate, e.g., hundreds of megabytes per second. Such high rates may be taxing for the communications bus of the vehicle. This disclosure addresses this issue with a shared buffer in memory. At least one publisher is programmed to share the buffer, resulting in a share message being transmitted through the service-oriented architecture, the share message indicating that the buffer is shared; write data to the buffer; upon writing the data to the buffer, transmit a publish message through the service-oriented architecture, the publish message indicating that the data is stored in the buffer, the publish message lacking the data; and wait until receiving an indication of a completion message from at least one subscriber before writing new data to the buffer. The at least one subscriber is programmed to read the data from the buffer; and upon reading the data in the buffer, transmit the completion message through the service-oriented architecture, the completion message indicating that the subscriber read the data. The use of the completion message can coordinate the frequency that the publisher writes data to the buffer to the frequency at which the subscribers can read the data from the buffer, thereby making the data transfer from the publisher to the subscribers more robust. The vehicle system can thus have higher throughput for the communications bus while maintaining low data loss.

A vehicle system includes a plurality of electronic control units. The electronic control units include respective processors and memories. The electronic control units are programmed to execute a service-oriented architecture including a publisher and a subscriber. The publisher is programmed to share a buffer in memory, resulting in a share message being transmitted through the service-oriented architecture, the share message indicating that the buffer is shared; write data to the buffer; upon writing the data to the buffer, transmit a publish message through the service-oriented architecture, the publish message indicating that the data is stored in the buffer, the publish message lacking the data; and wait until receiving an indication of a completion message from the subscriber before writing new data to the buffer. The subscriber is programmed to read the data from the buffer; and upon reading the data in the buffer, transmit the completion message through the service-oriented architecture, the completion message indicating that the subscriber read the data.

In an example, the subscriber may be a first subscriber; the completion message may be a first completion message; the service-oriented architecture may include a second subscriber programmed to, upon reading the data in the buffer, transmit a second completion message through the service-oriented architecture indicating that the second subscriber read the data; and the publisher may be further programmed to wait until receiving an indication of both the first completion message and the second completion message before writing new data to the buffer.

In an example, the share message may include a buffer identifier for the buffer, and the subscriber may be programmed to map the buffer in a subscriber address space of the subscriber based on the buffer identifier. In a further example, the subscriber may be programmed to transmit an input-output control (IOCTL) call to a device driver of the buffer, the IOCTL call including the buffer identifier, and map the buffer in the subscriber address space based on data received responsive to the IOCTL call.

In another further example, the subscriber may be programmed to unmap the buffer from the subscriber address space in response to receiving an unshare message indicating a transition by the publisher to no longer writing to the buffer.

In an example, the publisher may be programmed to, upon ceasing publishing to the buffer, transmit an unshare message through the service-oriented architecture, the unshare message indicating that the publisher is no longer writing to the buffer.

In an example, the service-oriented architecture may further include a device driver, the device driver programmed to track entities in the service-oriented architecture that are sharing the buffer. In a further example, the device driver may be programmed to track the entities that are sharing any of a plurality of buffers including the buffer.

In another further example, the device driver may be programmed to, in response to detecting that the subscriber shut down, transmit an unmapped message to the publisher, the unmapped message indicating that the subscriber is no longer reading the buffer.

In another further example, the device driver may be programmed to, in response to detecting that the publisher shut down, transmit an unshare message to the subscriber, the unshare message indicating a transition by the publisher to no longer writing to the buffer.

In another further example, the publisher may be programmed to, before writing data to the buffer for the first time, register with the device driver as a publisher, and the subscriber may be programmed to, before reading data from the buffer for the first time, register with the device driver as a subscriber.

In an example, one of the electronic control units may be programmed to actuate a component of a vehicle based on the subscriber reading the data from the buffer.

A computer includes a processor and a memory, and the memory stores instructions executable by the processor to share a buffer in memory, resulting in a share message being transmitted through a service-oriented architecture, the service-oriented architecture including a publisher and a subscriber, the share message indicating that the buffer is shared between the publisher and the subscriber; by the publisher, write data to the buffer; in response to the publisher writing data to the buffer, transmit a publish message through the service-oriented architecture, the publish message indicating that the data is stored in the buffer, the publish message lacking the data; receive an indication of a completion message via the service-oriented architecture, the completion message indicating that the subscriber read the data; and by the publisher, wait until receiving the indication of the completion message from the subscriber before writing new data to the buffer.

In an example, the subscriber may be a first subscriber; the completion message is a first completion message; and the instructions may further include instructions to receive a second completion message via the service-oriented architecture, the second completion message indicating that the second subscriber read the data; and wait until receiving an indication of both the first completion message and the second completion message before writing new data to the buffer.

In an example, the instructions may further include instructions to, upon the publisher ceasing publishing to the buffer, transmit an unshare message through the service-oriented architecture, the unshare message indicating that the publisher is no longer writing to the buffer.

A method includes sharing a buffer in memory, resulting in a share message being transmitted through a service-oriented architecture, the service-oriented architecture including a publisher and a subscriber, the share message indicating that the buffer is shared between the publisher and the subscriber; by the publisher, writing data to the buffer; in response to the publisher writing data to the buffer, transmitting a publish message through the service-oriented architecture, the publish message indicating that the data is stored in the buffer, the publish message lacking the data; upon reading the data in the buffer, transmitting a completion message through the service-oriented architecture, the completion message indicating that the subscriber read the data; and by the publisher, waiting until receiving an indication of the completion message from the subscriber before writing new data to the buffer.

In an example, the subscriber may be a first subscriber, the completion message may be a first completion message, and the method may further include receiving a second completion message via the service-oriented architecture, the second completion message indicating that a second subscriber read the data; and waiting until receiving an indication of both the first completion message and the second completion message before writing new data to the buffer.

In an example, the share message may include a buffer identifier for the buffer, and the method may further include, by the subscriber, mapping the buffer in a subscriber address space of the subscriber based on the buffer identifier.

In an example, the method may further include, by a device driver, tracking entities in the service-oriented architecture that are sharing the buffer. In a further example, the method may further include, by the device driver, tracking the entities that are sharing any of a plurality of buffers including the buffer.

With reference to the Figures, wherein like numerals indicate like parts throughout the several views, a vehicle system 105 of a vehicle 100 includes a plurality of electronic control units (ECUs) 110. The ECUs 110 include respective processors and memories. The ECUs 110 are programmed to execute a service-oriented architecture 200 including a publisher 205 and a subscriber 210. The publisher 205 is programmed to share a buffer 305 in memory, resulting in a share message being transmitted through the service-oriented architecture 200, the share message indicating that the buffer 305 is shared; write data to the buffer 305; upon writing the data to the buffer 305, transmit a publish message through the service-oriented architecture 200, the publish message indicating that the data is stored in the buffer 305, the publish message lacking the data; and wait until receiving an indication of a completion message from the subscriber 210 before writing new data to the buffer 305. The subscriber 210 is programmed to read the data from the buffer 305; and upon reading the data in the buffer 305, transmit the completion message through the service-oriented architecture 200, the completion message indicating that the subscriber 210 read the data.

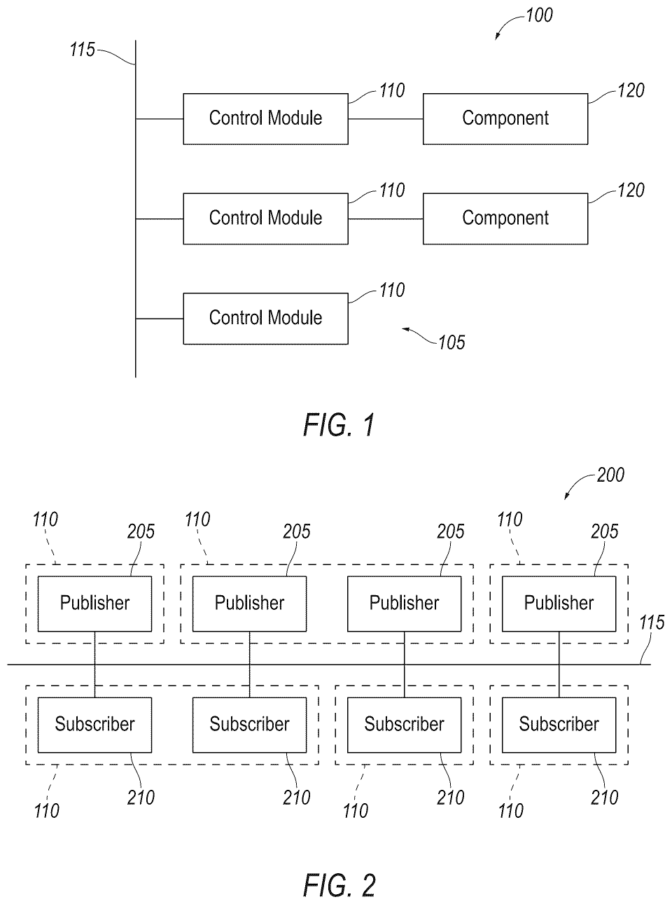

With reference to FIG. 1, the vehicle 100 may be any passenger or commercial automobile such as a car, a truck, a sport utility vehicle, a crossover, a van, a minivan, a taxi, a bus, etc. The vehicle 100 includes the vehicle system 105. The vehicle system 105 includes a plurality of the ECUs 110 and a communications network 115.

The ECUs 110 are microprocessor-based computing devices, e.g., generic computing devices including respective processors and a memories, electronic controllers or the like, field-programmable gate arrays (FPGA), application-specific integrated circuits (ASIC), combinations of the foregoing, etc. Typically, a hardware description language such as VHDL (VHSIC (Very High Speed Integrated Circuit) Hardware Description Language) is used in electronic design to describe digital and mixed-signal systems such as FPGA and ASIC. For example, an ASIC is manufactured based on VHDL programming provided pre-manufacturing, whereas logical components inside an FPGA may be configured based on VHDL programming, e.g., stored in a memory electrically connected to the FPGA circuit. Each ECU 110 can thus include a processor, a memory, etc. The memory of the ECU 110 can include media for storing instructions executable by the processor as well as for electronically storing data and/or databases, and/or the ECU 110 can include structures such as the foregoing by which programming is provided.

The ECUs 110 can operate different components 120 in the vehicle 100, e.g., a body control module, a powertrain control module, an accessories control module, etc. Examples of the components 120 include a propulsion system, a suspension system, a steering system, a user interface, a climate-control system, etc. The ECUs 110 can receive data from different components 120 connected to the ECUs 110, e.g., from sensors such as cameras, radars, etc.

The ECUs 110 may transmit and receive data through the communications network 115. The communications network 115 may be, e.g., a controller area network (CAN) bus, Ethernet, WiFi, Local Interconnect Network (LIN), onboard diagnostics connector (OBD-II), and/or any other wired or wireless communications network. The ECUs 110 may be communicatively coupled to each other and the components 120 via the communications network 115.

With reference to FIG. 2, a service-oriented architecture 200 is implemented on the ECUs 110 and the communications network 115. The ECUs 110 are programmed to execute the service-oriented architecture 200. The service-oriented architecture 200 is a software environment, i.e., implemented according to program instructions stored and executable by the ECUs 110, in which applications on devices on the communications network 115, e.g., on the ECUs 110, act as the publishers 205 or the subscribers 210 for message topics. A message topic is a category of data or update for which messages can be sent between entities 205, 210. Examples of message topics are different types or categories of data produced by the components 120, e.g., sensors; for example, a message topic could be image data from cameras or a particular camera, engine temperature from a temperature sensor, position updates from a GPS sensor, etc. When a publisher 205 transmits a message through the service-oriented architecture 200, the service-oriented architecture 200 delivers the message to the subscribers 210 of that message topic, e.g., subscribers 210 of that publisher 205. Alternatively or additionally, certain actions by publishers 205 are treated as events that the service-oriented architecture 200 reports to the subscribers 210.

An entity 205, 210, also called a client or a node, is a software program installed on one of the ECUs 110, e.g., a data-processing program for one of the sensors such as a camera, a navigation application, a driver-assistance system such as active cruise control, etc. The entities 205, 210 include the publishers 205 and the subscribers 210. A publisher 205 for a given message topic sends messages about the message topic to subscribers 210 of that message topic; e.g., the data-processing program can be a publisher 205 of image data, and the driver-assistance system can be a subscriber 210 of the image data. For another example, a GPS program can be a publisher 205 of position updates, and the navigation application can be a subscriber 210 of the position updates. Each ECU 110 can have multiple entities 205, 210 installed. An entity 205, 210 can be a publisher 205 or a subscriber 210 with respect to a specific message topic. The same entity 205, 210 can be a publisher 205 for one message topic and a subscriber 210 for a different message topic. The entities 205, 210 are connected to each other via the communications network 115 or directly via installation on the same or coupled ECUs 110.

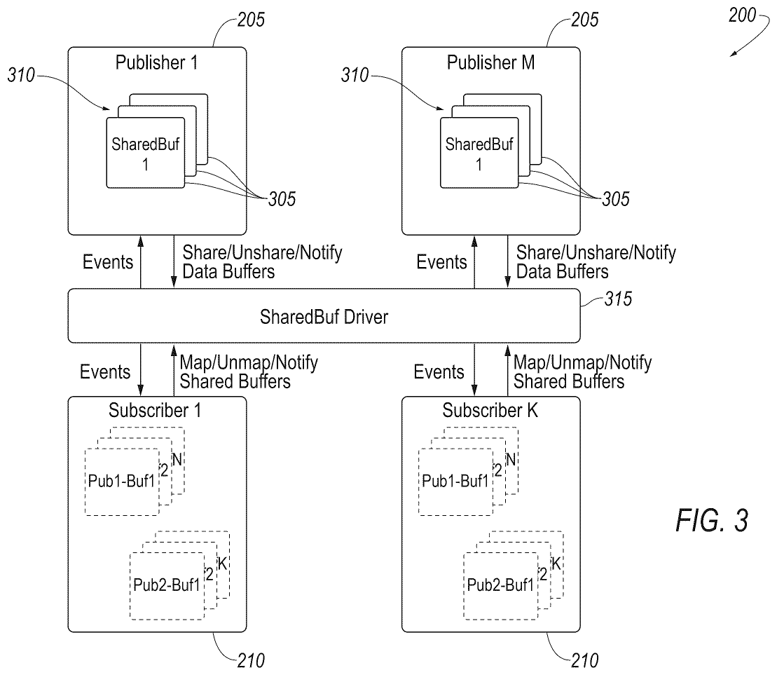

With reference to FIG. 3, data can be shared from the publishers 205 to the subscribers 210 via the buffers 305. In general, a buffer is a region of memory used to store data temporarily while the data is being transferred from one location, device, or process to another location, device, or process. Here, the buffers 305 are regions of memory in the publishers 205 to store data temporarily while the data is being processed by the subscribers 210. The buffers 305 can be specified at a fixed memory location in hardware or by using a virtual data buffer in software that points at a location in the physical memory. For example, the buffers 305 may be located in the virtual address space of the respective publisher 205. Each buffer 305 is contiguous in virtual address space even if not contiguous in physical space.

The buffers 305 may be organized together in one or a plurality of buffer pools 310. The buffer pools 310 may be, e.g., a consecutive region of memory that can be divided into the buffers 305. Each buffer pool 310 may be associated with or owned by a respective publisher 205. The buffers 305 in the same buffer pool 310 may be different sizes, i.e., have different storage capacity.

The service-oriented architecture 200 further includes a device driver 315. A device driver is a computer program that operates a particular type of device that is attached to a computer. A device driver provides a software interface to a particular type of hardware device so that an operating system or other computer program can access hardware functions. In this disclosure, the device operated by the device driver 315 is the memory being used for the buffers 305. The device driver 315 is programmed to track the entities 205, 210 in the service-oriented architecture 200 that are sharing any of the plurality of the buffers 305. For example, the device driver 315 may store a list of each publisher 205 that is able to write to each buffer 305 and each subscriber 210 that has access to read each buffer 305. The device driver 315 loads upon startup of the vehicle system 105, e.g., in response to the vehicle 100 starting.

The device driver 315 is programmed to, upon loading, generate a plurality of device nodes. The device driver 315 may generate one device node for each buffer pool 310. Each device node represents one of the buffer pools 310 for sharing the buffers 305 between a publisher 205 and the subscribers 210 of that publisher 205.

The publisher 205 may be programmed to obtain access to the buffer pool 310 associated with the publisher 205. For example, the publisher 205 may transmit an open message to the device driver 315 associating a buffer pool 310 of the publisher 205 with a specific device node. The publisher 205 opens the device node, registers the publisher 205 as a publisher with the device node, and registers the buffers 305 to add to the respective buffer pool 310 for sharing with the subscribers 210. The subscriber 210 opens the device node and registers the subscriber 210 as a subscriber with the device node. The device node notifies the subscriber 210 of the buffers 305 shared by the publisher 205.

The entities 205, 210 register with the device driver 315. The publisher 205 may be programmed to register with the device driver 315 as a publisher 205. For example, the publisher 205 may transmit a message, e.g., a system call, to the device driver 315 indicating that the publisher 205 is a publisher. The device driver 315 may maintain a list of the publishers 205 that have registered with the device driver 315, along with the respective buffer pools 310. The publisher 205 may have exclusive ability to write to the buffers 305 in the allocated buffer pool 310.

The subscriber 210 may be programmed to, before reading data from a buffer 305 for the first time, register with the device driver 315 as a subscriber 210. (The subscriber 210 also maps the buffer 305 before reading from the buffer 305 for the first time, as described below.) For example, the subscriber 210 may transmit a message to the device driver 315 indicating that the subscriber 210 is a subscriber 210. The device driver 315 may maintain a list of the subscribers 210 that have registered with the device driver 315.

The publisher 205 is programmed to share a buffer 305 in memory. For example, the publisher 205 may register the buffers 305 in the buffer pool 310 allocated to the publisher 205 with the device driver 315. The publisher 205 may assign a buffer identifier to each of the buffers 305 in the buffer pool 310 and transmit the buffer identifiers to the device driver 315. The device driver 315 may maintain a list of the buffer identifiers with corresponding memory addresses of the respective buffers 305, e.g., with memory addresses for physical pages at which each buffer 305 is located. Each buffer identifier is unique to the respective buffer 305. Tracking the memory addresses of the buffers 305 with the buffer identifiers can permit the buffers 305 to be different sizes.

Sharing of the buffer 305 by the publisher 205 results in a share message being transmitted through the service-oriented architecture 200. The share message indicates that the buffer 305 is shared. For example, the device driver 315 or the service-oriented architecture 200 transmits the share message to the subscribers 210 of the publisher 205. The device driver 315 or the service-oriented architecture 200 includes the buffer identifier in the share message. The share message includes the buffer identifier for the buffer 305. The service-oriented architecture 200 delivers the message to the subscribers 210 of that publisher 205, including the buffer identifier.

The subscriber 210 may be programmed to obtain access to one of the buffer pools 310. For example, the subscriber 210 may transmit the open message to the device driver 315 requesting access to a buffer pool 310, e.g., to the buffer pool 310 of the publisher 205 to which the subscriber 210 is subscribed. The device driver 315 may, upon receiving the open message from the subscriber 210, grant the subscriber 210 access to the buffer pool 310 via the device node.

The subscriber 210 may be programmed to map the buffer 305 in a subscriber address space of the subscriber 210 based on the buffer identifier, e.g., in response to receiving the share message containing the buffer identifier. The subscriber address space is data indicating memory addresses of the buffers 305 (and possibly other memory addresses) in a manner permitting the subscriber 210 to access the memory at the memory addresses. For example, the subscriber 210 may acquire data indicating the buffer 305 by transmitting an input-output control (IOCTL) call to the device driver 315. The IOCTL call includes the buffer identifier and requests the data indicating the buffer 305, e.g., data indicating or related to the memory address, e.g., a size and map offset of the buffer 305. The device driver 315 responds to the IOCTL message by transmitting the requested data, e.g., the size and map offset corresponding to the buffer identifier. The subscriber 210 maps the buffer 305 in the subscriber address space based on the data received responsive to the IOCTL call, e.g., the size and map offset. For example, the subscriber 210 then passes the received data, e.g., the size and map offset, in a system call to map the buffer 305 to the subscriber address space. The device driver 315 maps the associated physical pages to in the subscriber's address space, i.e., associates the corresponding subscriber's address space for a buffer 305 with the physical pages of that buffer 305. The system call returns the memory address for use in the subscriber address space, and the subscriber 210 stores, e.g., caches, the memory address in the subscriber address space. The memory address may be, e.g., a virtual address.

The publisher 205 is programmed to write data to the buffer 305. For example, the publisher 205 may write the data to the buffer 305 in response to the data being generated by the component 120 to which the publisher 205 is coupled, e.g., a sensor. The publisher 205 is further programmed to, upon writing the data to the buffer 305, transmit a publish message through the service-oriented architecture 200. The publish message indicates that the data is stored in the buffer 305. The publish message lacks the data itself. For example, the publish message includes the buffer identifier for the buffer 305 containing the data. Accordingly, the publish message may be significantly smaller than the data, e.g., on the order of bytes instead of megabytes, and the publish message correspondingly results in higher throughput than transmitting the data through the service-oriented architecture 200. The service-oriented architecture 200 delivers the publish message to the subscribers 210 of that publisher 205, e.g., as a notify event of the service-oriented architecture 200.

The subscriber 210 is programmed to read the data from the buffer 305, e.g., in response to receiving the publish message. For example, the subscriber 210 may look up the memory address from the table using the buffer identifier from the publish message, and the subscriber 210 may then read the data from that memory address. The subscriber 210 is further programmed to, upon reading the data in the buffer 305, transmit a completion message through the service-oriented architecture 200. The completion message indicates that the subscriber 210 read the data.

At least one of the ECUs 110 may be programmed to actuate a component 120 of the vehicle 100 based on the subscriber 210 reading the data from the buffer 305. For example, the subscriber 210 may be or be part of an advanced driver assistance systems (ADAS). ADAS are electronic technologies that assist drivers in driving and parking functions. Examples of ADAS include forward proximity detection, lane-departure detection, blind-spot detection, adaptive cruise control, and lane-keeping assistance systems. As one example, the publisher 205 may be a driver for a camera, the data in the buffer 305 may be image data of a road, the subscriber 210 may detect lane lines in the image data, and one of the ECUs 110 may use the detected lane lines as an input to a lane-keeping assistance system that actuates the steering system.

The service-oriented architecture 200 delivers an indication of the completion message to the publisher 205. For example, the service-oriented architecture 200 may deliver the completion message to the publisher 205. For another example, the service-oriented architecture 200 may deliver a notification that the completion message was received from the subscriber 210. For another example, the service-oriented architecture 200 may deliver a notification that completion messages were received from a plurality of the subscribers 210 of that publisher 205, e.g., a first completion message from a first subscriber 210, a second completion message from a second subscriber 210, etc. The plurality of subscribers 210 may be all the subscribers 210 of that publisher 205 or a designated subset of the subscribers 210 of that publisher 205. The status of a subscriber 210 as belonging or not belonging to the designated subset may be stored by the device driver 315. For another example, the service-oriented architecture 200 may deliver a notification containing a count of the number of completion messages received, either from any subscriber 210 of that publisher 205 or from one of the subscribers 210 in the designated subset.

The publisher 205 is programmed to wait until receiving the indication of the completion message from the subscriber 210 before writing new data to the buffer 305. For example, the publisher 205 may wait until receiving an indication that the completion messages were received from all or a designated subset of the subscribers 210 of that publisher 205. For example, the publisher 205 may wait until receiving a notification with a count that exceeds a threshold. The threshold may be the number of subscribers 210 of that publisher 205 or the number of subscribers 210 in the designated subset. The publisher 205 may receive a list of the subscribers 210 of that publisher 205 from the device driver 315, e.g., in response to a request for the list of the subscribers 210, from which to determine the threshold. Waiting for the indication of the completion message(s) can help ensure that the publisher 205 is outputting data at the same rate that the subscriber(s) 210 are inputting the data.

An unshare message indicates a transition by the publisher 205 to no longer writing to the buffer 305. The publisher 205 may transition to no longer write to the buffer 305 if, e.g., the publisher 205 shuts down. The publisher 205 may shut itself down under certain circumstances, such as the vehicle system 105 shutting down, a feature using the publisher 205 shutting down, or an unexpected shutdown. The publisher 205 may be programmed to, upon ceasing publishing to the buffer 305 (e.g., as a result of a planned shutdown), transmit a close message to the device driver 315 and transmit the unshare message through the service-oriented architecture 200. The service-oriented architecture 200 delivers the unshare message to the subscribers 210 of the publisher 205. The publisher 205 may, upon receiving unmapped messages from the subscribers 210 of that publisher 205 (described below), de-allocate the buffer 305 and shut down the device node for that buffer 305. The publisher 205 may wait to receive the unmapped messages before shutting itself down and releasing its resources. The device driver 315 may be programmed to, in response to detecting that the publisher 205 shut down, transmit the unshare message to the subscribers 210 of the publisher 205.

The subscriber 210 may be programmed to unmap the buffer 305 from the subscriber address space, e.g., in response to receiving the unshare message or in response to shutting down. For example, the subscriber 210 may delete the memory address and corresponding buffer identifier from the cached table. The device driver 315 may be programmed to, upon unmapping the buffer 305 from the subscriber address space, transmit an unmapped message through the service-oriented architecture 200. The unmapped message indicates that the subscriber 210 is no longer reading the buffer 305. The service-oriented architecture 200 may deliver the unmapped message to the publisher 205, and the publisher 205 may update the list of subscribers 210 by deleting the subscriber 210. The device driver 315 may be programmed to, in response to detecting that the subscriber 210 shut down (e.g., unexpectedly), transmit the unmapped message to the publisher 205. The unmapped message may help the publisher 205 to not wait for inactive subscribers 210 before writing new data to the buffer 305. If the subscriber 210 is shutting down, the subscriber 210 may wait until unmapping the buffer 305 before shutting itself down and releasing its resources.

The vehicle system 105 may shut down, e.g., in response to the vehicle 100 turning off. In response to the vehicle system 105 shutting down, the publisher 205 may unshare the buffer 305 and transmit the unshare message, the subscribers 210 may unmap the memory address of the buffer 305, and the unmapped message may be transmitted to the publisher 205, as all described above. The device driver 315 then unloads the device node. Once all the device nodes are unloaded, the device driver 315 then shuts itself down as part of the vehicle system 105 shutting down.

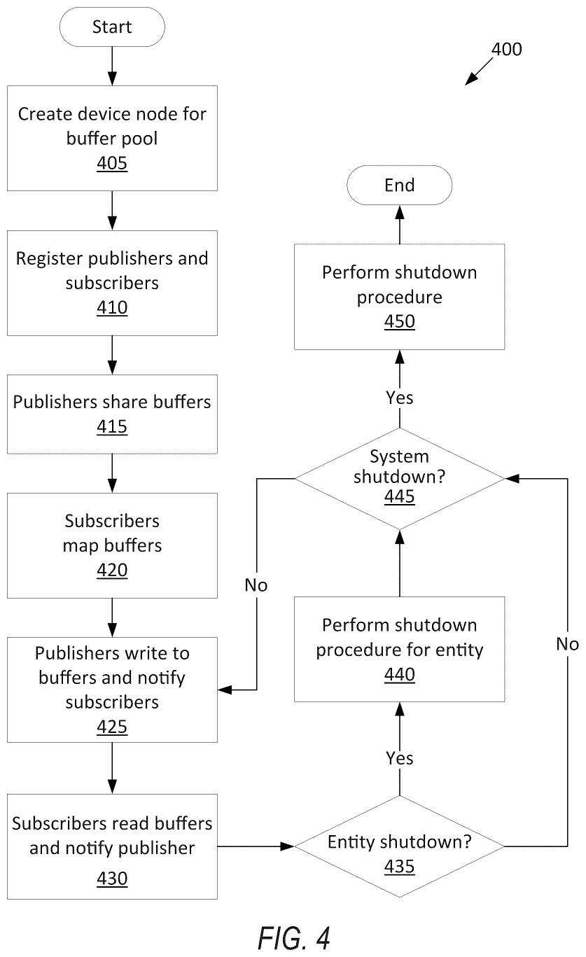

FIG. 4 is a flowchart illustrating an example process 400 for sharing the buffers 305 between the entities 205, 210 of the service-oriented architecture 200, e.g., sharing the buffers 305 of the publishers 205 with the subscribers 210. The memories of the ECUs 110 store executable instructions for performing the steps of the process 400 and/or programming can be implemented in structures such as mentioned above. The process 400 may begin when the vehicle system 105 starts, e.g., boots up, e.g., in response to the vehicle 100 starting. As a general overview of the process 400, the device driver 315 creates the device node for the buffer pool 310 and, when the publishers 205 and subscribers 210 start, registers the publishers 205 and subscribers 210 of the buffer pool 310. The publishers 205 share the buffers 305 with their subscribers 210. The subscribers 210 map the memory addresses of the buffers 305. For as long as the publishers 205 and subscribers 210 continue executing, the publishers 205 write data to the buffers 305 and transmit publish messages, and the subscribers 210 read the data from the buffers 305 and transmit completion messages. In response to an entity 205, 210 shutting down, the buffers 305 are unshared by the publisher 205 and unmapped by the subscribers 210. In response to a shutdown of the device driver 315 or vehicle system 105, the buffers 305 are unshared by the publisher 205 and unmapped by the subscribers 210, and the device node is unloaded.

The process 400 begins in a block 405, in which the device driver 315 generates the device nodes for the buffer pools 310, as described above.

Next, in a block 410, the publishers 205 and the subscribers 210 open the device nodes to register with the device driver 315, as described above.

Next, in a block 415, the publishers 205 share the buffers 305, and the share messages are delivered to the subscribers 210, as described above.

Next, in a block 420, the subscribers 210 map the memory addresses of the buffers 305, as described above.

Next, in a block 425, the publisher 205 writes data to the buffer 305 and transmits a publish message, as described above. After the first data is written to a buffer 305, the publisher 205 waits until receiving an indication of the completion message(s) from the subscribers 210 before writing new data to the buffer 305, as described above.

Next, in a block 430, the subscribers 210 read the data from the buffer 305 in response to receiving the publish message and transmit the completion messages, as described above. At least one of the ECUs 110 may actuate a component 120 of the vehicle 100 based on the subscriber 210 reading the data from the buffer 305, as described above.

Next, in a decision block 435, the device driver 315 determines whether one of the entities 205, 210 shut down, as described above. In response to an entity 205, 210 shutting down, the process 400 proceeds to a block 440. In response to the entities 205, 210 remaining running, the process 400 proceeds to a decision block 445.

In the block 440, the vehicle system 105 performs a shutdown procedure for the entity 205, 210. For example, if a publisher 205 shuts down, then the publisher 205 transmits an unshare message, the subscribers 210 of that publisher 205 unmap the buffers 305, the device driver 315 transmits corresponding unmapped messages, and the publisher 205 completes the shutdown upon receiving the unmapped messages, as described above. For another example, if a subscriber 210 shuts down, then the device driver 315 transmits an unmapped message to the publishers 205 to which that subscriber 210 is subscribed, and the publishers 205 may remove the subscriber 210 from lists or counts of their subscribers, as described above. The process 400 proceeds from the block 440 to a decision block 445.

In the decision block 445, the device driver 315 determines whether the device driver 315 or vehicle system 105 is shutting down. In response to the device driver 315 or vehicle system 105 shutting down, the process 400 proceeds to a block 450. In response to the device driver 315 and the vehicle system 105 remaining running, the process 400 returns to the block 425 to continue sharing data from the publisher 205 to the subscribers 210 via the buffers 305.

In the block 450, the vehicle system 105 performs the shutdown procedure described above with respect to the block 440 for all the entities 205, 210. After the entities 205, 210 are shut down, the device driver 315 shuts down, and the vehicle system 105 shuts down. After the block 450, the process 400 ends.

In general, the computing systems and/or devices described may employ any of a number of computer operating systems, including, but by no means limited to, versions and/or varieties of the Ford Sync® application, AppLink/Smart Device Link middleware, the Microsoft Automotive® operating system, the Microsoft Windows® operating system, the Unix operating system (e.g., the Solaris® operating system distributed by Oracle Corporation of Redwood Shores, California), the AIX UNIX operating system distributed by International Business Machines of Armonk, New York, the Linux operating system, the Mac OSX and iOS operating systems distributed by Apple Inc. of Cupertino, California, the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board vehicle computer, a computer workstation, a server, a desktop, notebook, laptop, or handheld computer, or some other computing system and/or device.

Computing devices generally include computer-executable instructions, where the instructions may be executable by one or more computing devices such as those listed above. Computer executable instructions may be compiled or interpreted from computer programs created using a variety of programming languages and/or technologies, including, without limitation, and either alone or in combination, Java™, C, C++, Matlab, Simulink, Stateflow, Visual Basic, Java Script, Python, Perl, HTML, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random access memory, etc.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Instructions may be transmitted by one or more transmission media, including fiber optics, wires, wireless communication, including the internals that comprise a system bus coupled to a processor of a computer. Common forms of computer-readable media include, for example, RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), a nonrelational database (NoSQL), a graph database (GDB), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

In the drawings, the same reference numbers indicate the same elements. Further, some or all of these elements could be changed. With regard to the media, processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. Operations, systems, and methods described herein should always be implemented and/or performed in accordance with an applicable owner's/user's manual and/or safety guidelines.

The disclosure has been described in an illustrative manner, and it is to be understood that the terminology which has been used is intended to be in the nature of words of description rather than of limitation. Use of “in response to,” “upon determining,” etc. indicates a causal relationship, not merely a temporal relationship. The adjectives “first” and “second” are used throughout this document as identifiers and are not intended to signify importance, order, or quantity. Many modifications and variations of the present disclosure are possible in light of the above teachings, and the disclosure may be practiced otherwise than as specifically described.

What is claimed is:

1. A vehicle system comprising a plurality of electronic control units, the electronic control units including respective processors and memories, the electronic control units programmed to execute a service-oriented architecture including:
a publisher; and
a subscriber;
the publisher being programmed to:
share a buffer in memory, resulting in a share message being transmitted through the service-oriented architecture, the share message indicating that the buffer is shared;
write data to the buffer;
upon writing the data to the buffer, transmit a publish message through the service-oriented architecture, the publish message indicating that the data is stored in the buffer, the publish message lacking the data; and
wait until receiving an indication of a completion message from the subscriber before writing new data to the buffer; and
the subscriber being programmed to:
read the data from the buffer; and
upon reading the data in the buffer, transmit the completion message through the service-oriented architecture, the completion message indicating that the subscriber read the data.

2. The vehicle system of claim 1, wherein
the subscriber is a first subscriber;
the completion message is a first completion message;
the service-oriented architecture includes a second subscriber programmed to, upon reading the data in the buffer, transmit a second completion message through the service-oriented architecture indicating that the second subscriber read the data; and
the publisher is further programmed to wait until receiving an indication of both the first completion message and the second completion message before writing new data to the buffer.

3. The vehicle system of claim 1, wherein the share message includes a buffer identifier for the buffer, and the subscriber is programmed to map the buffer in a subscriber address space of the subscriber based on the buffer identifier.

4. The vehicle system of claim 3, wherein the subscriber is programmed to transmit an input-output control (IOCTL) call to a device driver of the buffer, the IOCTL call including the buffer identifier, and map the buffer in the subscriber address space based on data received responsive to the IOCTL call.

5. The vehicle system of claim 3, wherein the subscriber is programmed to unmap the buffer from the subscriber address space in response to receiving an unshare message indicating a transition by the publisher to no longer writing to the buffer.

6. The vehicle system of claim 1, wherein the publisher is programmed to, upon ceasing publishing to the buffer, transmit an unshare message through the service-oriented architecture, the unshare message indicating that the publisher is no longer writing to the buffer.

7. The vehicle system of claim 1, wherein the service-oriented architecture further includes a device driver, the device driver programmed to track entities in the service-oriented architecture that are sharing the buffer.

8. The vehicle system of claim 7, wherein the device driver is programmed to track the entities that are sharing any of a plurality of buffers including the buffer.

9. The vehicle system of claim 7, wherein the device driver is programmed to, in response to detecting that the subscriber shut down, transmit an unmapped message to the publisher, the unmapped message indicating that the subscriber is no longer reading the buffer.

10. The vehicle system of claim 7, wherein the device driver is programmed to, in response to detecting that the publisher shut down, transmit an unshare message to the subscriber, the unshare message indicating a transition by the publisher to no longer writing to the buffer.

11. The vehicle system of claim 7, wherein the publisher is programmed to, before writing data to the buffer for the first time, register with the device driver as a publisher, and the subscriber is programmed to, before reading data from the buffer for the first time, register with the device driver as a subscriber.

12. The vehicle system of claim 1, wherein one of the electronic control units is programmed to actuate a component of a vehicle based on the subscriber reading the data from the buffer.

13. A computer comprising a processor and a memory, the memory storing instructions executable by the processor to:
share a buffer in memory, resulting in a share message being transmitted through a service-oriented architecture, the service-oriented architecture including a publisher and a subscriber, the share message indicating that the buffer is shared between the publisher and the subscriber;
by the publisher, write data to the buffer;
in response to the publisher writing data to the buffer, transmit a publish message through the service-oriented architecture, the publish message indicating that the data is stored in the buffer, the publish message lacking the data;
receive an indication of a completion message via the service-oriented architecture, the completion message indicating that the subscriber read the data; and
by the publisher, wait until receiving the indication of the completion message from the subscriber before writing new data to the buffer.

14. The computer of claim 13, wherein
the subscriber is a first subscriber;
the completion message is a first completion message; and
the instructions further include instructions to:
receive a second completion message via the service-oriented architecture, the second completion message indicating that the second subscriber read the data; and
wait until receiving an indication of both the first completion message and the second completion message before writing new data to the buffer.

15. The computer of claim 13, wherein the instructions further include instructions to, upon the publisher ceasing publishing to the buffer, transmit an unshare message through the service-oriented architecture, the unshare message indicating that the publisher is no longer writing to the buffer.

16. A method comprising:
sharing a buffer in memory, resulting in a share message being transmitted through a service-oriented architecture, the service-oriented architecture including a publisher and a subscriber, the share message indicating that the buffer is shared between the publisher and the subscriber;
by the publisher, writing data to the buffer;
in response to the publisher writing data to the buffer, transmitting a publish message through the service-oriented architecture, the publish message indicating that the data is stored in the buffer, the publish message lacking the data;
upon reading the data in the buffer, transmitting a completion message through the service-oriented architecture, the completion message indicating that the subscriber read the data; and
by the publisher, waiting until receiving an indication of the completion message from the subscriber before writing new data to the buffer.

17. The method of claim 16, wherein the subscriber is a first subscriber, and the completion message is a first completion message, the method further comprising:
receiving a second completion message via the service-oriented architecture, the second completion message indicating that a second subscriber read the data; and
waiting until receiving an indication of both the first completion message and the second completion message before writing new data to the buffer.

18. The method of claim 16, wherein the share message includes a buffer identifier for the buffer, the method further comprising, by the subscriber, mapping the buffer in a subscriber address space of the subscriber based on the buffer identifier.

19. The method of claim 16, further comprising, by a device driver, tracking entities in the service-oriented architecture that are sharing the buffer.

20. The method of claim 19, further comprising, by the device driver, tracking the entities that are sharing any of a plurality of buffers including the buffer.
